(19) United States
(12) Patent Application Publication
(10) Pub. No.: US 2026/0225652 A1
(43) Pub. Date: Aug. 6, 2026

(54) REAR-WHEEL STEERING CONTROL APPARATUS AND METHOD FOR VEHICLE

(71) Applicant: HYUNDAI MOBIS CO., LTD., Seoul (KR)

(72) Inventor: Kyoung Wook MIN, Yongin-si (KR)

(73) Assignee: HYUNDAI MOBIS CO., LTD., Seoul (KR)

(21) Appl. No.: 19/463,902

(22) Filed: Jan. 29, 2026

(30) Foreign Application Priority Data
Feb. 4, 2025 (KR) 10-2025-0014106

(51) Int. Cl. B62D 7/15

(52) U.S. Cl. CPC B62D 7/159

(57) ABSTRACT

A rear-wheel steering control apparatus and method for a vehicle. The rear-wheel steering control apparatus includes: an input module to receive information about a state of the vehicle; a rear-wheel steering driving module to steer rear wheels of the vehicle according to a rear-wheel steering angle; and a processor operatively coupled to the input module and the rear-wheel steering driving module. The processor receives a shift stage, a vehicle speed, and a front-wheel steering angle from the input module, and, when a set condition is satisfied, sets the rear-wheel steering angle to a neutral state and drives the rear-wheel steering driving module.

### CROSS-REFERENCE TO RELATED APPLICATION

This application claims priority from and the benefit of Korean Patent Application No. 10-2025-0014106, filed on February 04, 2025, which is hereby incorporated by reference for all purposes as if set forth herein.

### BACKGROUND

### FIELD

Exemplary embodiments of the present disclosure relate to a rear-wheel steering control apparatus and method for a vehicle, and more particularly, to a rear-wheel steering control apparatus and method for a vehicle, capable of controlling rear wheels in an in-phase state, a counter-phase state, or a neutral state based on set conditions.

### DISCUSSION OF THE BACKGROUND

Active front steering (AFS) systems applied to vehicles include a variable steering gear ratio device disposed between a steering wheel and a steering actuator, and receive a steering angle of the steering wheel, output a varied rotation angle to an AFS actuator, and vary a steering gear ratio, thereby providing front-wheel steering responsiveness and driving stability.

In addition, rear-wheel steering (RWS) systems receive the steering angle of the steering wheel and a vehicle speed, determine a rear-wheel steering angle, and drive an RWS actuator to control the rear-wheel steering angle, thereby providing rear-wheel steering responsiveness and driving stability.

The rear-wheel steering systems steer rear wheels in a direction opposite to a steering direction of front wheels (that is, steer the rear wheels in a counter-phase manner with the front wheels), when a vehicle travels at a low speed, thereby reducing a turning radius and improving rear-wheel steering responsiveness, and steer the rear wheels in the same direction as the steering direction of the front wheels (that is, steer the rear wheels in an in-phase manner with the front wheels), when the vehicle travels at a high speed, thereby reducing a yaw rate and providing driving stability.

For rear-wheel steering control, a control device such as an RWS electronic control unit (ECU) receives signals including a steering angle and a vehicle speed, calculates a target rear-wheel steering angle, and controls rear-wheel steering based on the calculated target rear-wheel steering angle.

As described above, such a rear-wheel steering system steers the rear wheels in the counter-phase manner with the front wheels when the vehicle travels at a low speed, and steers the rear wheels in an in-phase manner with the front wheels when the vehicle travels at a high speed, thereby reducing a yaw rate and providing driving stability.

However, even during reverse driving of the vehicle, the rear wheels are controlled using the same control scheme and the same operating level as during forward driving, thereby increasing instability.

That is, during reverse driving, stability is not significantly affected in a high-speed condition due to in-phase control, but in a low-speed condition equal to or lower than a transition speed, vehicle instability is significantly increased due to counter-phase control.

For a general vehicle driver, a reverse driving situation itself is not a familiar situation, and when counter-phase control is performed through rear-wheel steering, the vehicle moves significantly even with a small steering input, thereby increasing yaw and roll, which may result in degradation in steering performance and ride comfort, thus increasing instability during reverse driving and increasing a probability of an accident.

The above information disclosed in this Background section is only for enhancement of understanding of the background and therefore it may contain information that does not form the prior art that is already known in this country to a person of ordinary skill in the art.

### SUMMARY

Various embodiments are directed to providing a rear-wheel steering control apparatus and method for vehicles capable of improving stability during reverse driving by controlling rear wheels in an in-phase state, a counter-phase state, or a neutral state based on set conditions when steering the rear wheels relative to a front-wheel steering angle.

Objects of embodiments are not limited to the objects described herein, and other objects that are not described will be clearly understood by a person skilled in the art from the description below.

A rear-wheel steering control apparatus for a vehicle according to an embodiment of the present disclosure includes: an input module configured to receive information about a state of the vehicle; a rear-wheel steering driving module configured to steer rear wheels of the vehicle according to a rear-wheel steering angle; and a processor operatively coupled to the input module and the rear-wheel steering driving module. The processor may be configured to receive a shift stage, a vehicle speed, and a front-wheel steering angle from the input module, and, when a set condition is satisfied, set the rear-wheel steering angle to a neutral state and drive the rear-wheel steering driving module.

In an embodiment, the set condition may include a condition in which the shift stage is reverse and the vehicle speed exceeds a first preset vehicle speed and is less than a second preset vehicle speed.

In an embodiment, the processor may be configured to control the rear-wheel steering angle in a counter-phase state when the vehicle speed is equal to or lower than the first preset vehicle speed.

In an embodiment, the processor may be configured to control the rear-wheel steering angle in an in-phase state when the vehicle speed is equal to or higher than the second preset vehicle speed.

In an embodiment, the processor may be configured to set the rear-wheel steering angle to the neutral state and drive the rear-wheel steering driving module such that the rear-wheel steering angle satisfies a preset inclination when the rear-wheel steering angle is released from the neutral state.

A rear-wheel steering control method for a vehicle according to an embodiment of the present disclosure includes: receiving, by a processor, a shift stage, a vehicle speed, and a front-wheel steering angle from an input module; determining, by the processor, whether the shift stage and the vehicle speed satisfy a set condition; and when it is determined that the set condition is satisfied, setting, by the processor, a rear-wheel steering angle to a neutral state and driving a rear-wheel steering driving module.

In an embodiment, the set condition may include a condition in which the shift stage is reverse and the vehicle speed exceeds a first preset vehicle speed and is less than a second preset vehicle speed.

In an embodiment, the rear-wheel steering control method may further include, when the vehicle speed is equal to or lower than the first preset vehicle speed, controlling, by the processor, the rear-wheel steering angle in a counter-phase state.

In an embodiment, the rear-wheel steering control method may further include, when the vehicle speed is equal to or higher than the second preset vehicle speed, controlling, by the processor, the rear-wheel steering angle in an in-phase state.

In an embodiment, the driving of the rear-wheel steering driving module may include setting, by the processor, the rear-wheel steering angle to the neutral state and driving the rear-wheel steering driving module such that the rear-wheel steering angle satisfies a preset inclination when the rear-wheel steering angle is released from the neutral state.

In a rear-wheel steering control apparatus and method for a vehicle according to an aspect of the present disclosure, when rear wheels are steered relative to a front-wheel steering angle, neutral control is performed in a low-speed range during reverse driving and counter-phase control is performed during parking in an extremely low-speed range, thereby improving stability during reverse driving and increasing steering efficiency by reducing a turning radius.

The effects obtainable in the present disclosure are not limited to the above-mentioned effects, and other effects that are not mentioned may be clearly understood by those skilled in the art to which the present disclosure belongs, from the description herein.

### BRIEF DESCRIPTION OF THE DRAWINGS

FIG. 1 is a block diagram illustrating a rear-wheel steering control apparatus for a vehicle according to an embodiment of the present disclosure.

FIGS. 2A and 2B are views illustrating a rear-wheel steering operation of a vehicle controlled by the rear-wheel steering control apparatus according to an embodiment of the present disclosure.

FIG. 3 is a flowchart illustrating a rear-wheel steering control method for a vehicle according to an embodiment of the present disclosure.

### DETAILED DESCRIPTION

Hereinafter, a rear-wheel steering control apparatus and method for a vehicle according to an embodiment of the present disclosure will be described.

It should be noted that the drawings are not to precise scale and may be exaggerated in thickness of lines or sizes of components for descriptive convenience and clarity only. Furthermore, the terms as used herein are defined by taking functions of the present disclosure into account and can be changed according to the custom or intention of users or operators. Therefore, definition of the terms should be made according to the overall disclosures set forth herein.

Hereinafter, embodiments of the present disclosure will be described in detail with reference to the accompanying drawings so as to be easily implemented by those skilled in the art. However, the present disclosure may be implemented in various ways, and is not limited to the exemplary forms described herein. In the drawings, in order to clearly describe the present disclosure, portions which are not related to the description of the present disclosure will be omitted, and similar portions are denoted by similar reference numerals throughout the specification.

Throughout the specification, when a portion is described as including a certain component, the description is not intended to exclude other components, unless otherwise stated, and the portion may further include additional components.

Furthermore, an implementation described in this specification may be realized as a method or process, an apparatus, a software program, a data stream or a signal, for example. Although the present disclosure has been discussed only in the context of a single form of an implementation (e.g., discussed as only a method), an implementation having a discussed characteristic may also be realized in another form (e.g., an apparatus or a program). The apparatus may be implemented as proper hardware, software or firmware. The method may be implemented in an apparatus, such as a processor commonly referring to a processing device, including a computer, a microprocessor, an integrated circuit or a programmable logic device, for example.

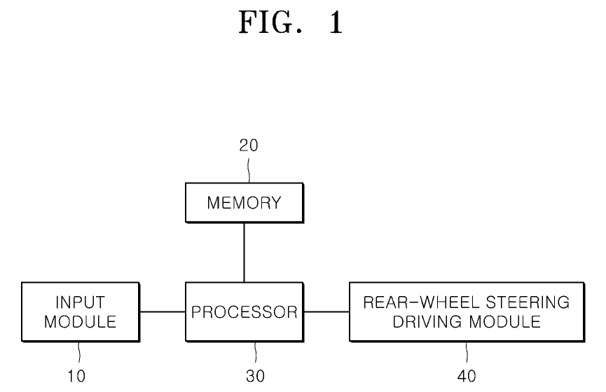

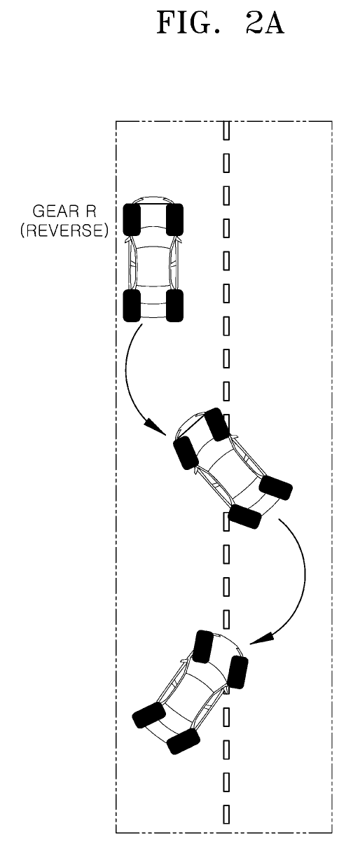

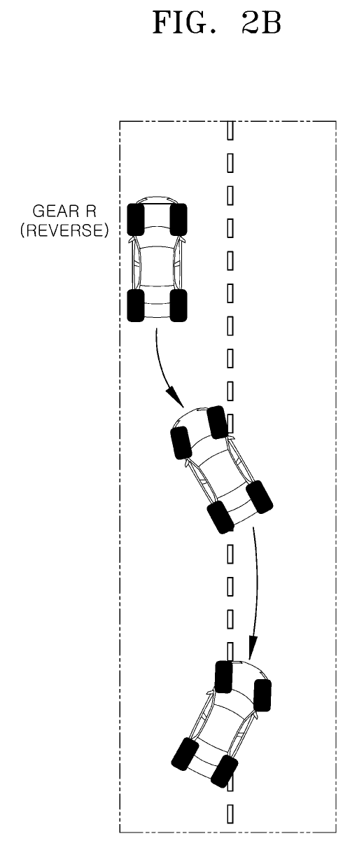

FIG. 1 is a block diagram illustrating a rear-wheel steering control apparatus for a vehicle according to an embodiment of the present disclosure. FIG. 2 is a view illustrating a rear-wheel steering operation of a vehicle controlled by the rear-wheel steering control apparatus according to an embodiment of the present disclosure.

As illustrated in FIG. 1, the rear-wheel steering control apparatus for a vehicle according to an embodiment of the present disclosure may include an input module 10, a rear-wheel steering driving module 40, a memory 20, and a processor 30.

The input module 10 may receive information about a state of the vehicle from an in-vehicle control apparatus through controller area network (CAN) communication.

The vehicle state received through the input module 10 may include a yaw rate value as well as a shift stage, a vehicle speed, and a front-wheel steering angle.

The rear-wheel steering driving module 40 may steer rear wheels of the vehicle using a driving force of a motor in accordance with a rear-wheel steering angle output from the processor 30.

The memory 20 may store an execution program for operation of the rear-wheel steering control apparatus of a vehicle and data related to the execution program, and stored information may be independently selected by the processor 30 as needed.

In other words, the memory 20 may store various types of data generated during execution of an operating system or an application (a program or an applet) configured to drive the rear-wheel steering control apparatus of the vehicle. The memory 20 collectively refers to a nonvolatile storage device configured to retain stored information even when power is not supplied and a volatile storage device that requires power to retain stored information. In addition, the memory 20 may perform a function of temporarily or permanently storing data processed by the processor 30.

For example, the memory 20 may include a magnetic storage medium or a flash storage medium, in addition to a volatile storage device that requires power to retain stored information, but the scope of the present disclosure is not limited thereto.

The processor 30 may be operatively coupled to the input module 10, the rear-wheel steering driving module 40, and the memory 20, and may copy, to a random access memory (RAM), various programs stored in the memory 20 to control overall operation of the rear-wheel steering control apparatus, and execute the programs to perform various operations.

In various embodiments, the processor 30 may be implemented as a digital signal processor (DSP), a microprocessor, or a time controller (TCON). However, the processor 30 is not limited thereto, and the processor 30 may include or be defined as one or more of a central processing unit (CPU), a micro controller unit (MCU), a micro processing unit (MPU), a controller, an application processor (AP), a communication processor (CP), or an advanced RISC machine (ARM) processor. In addition, the processor 30 may be implemented as a system on chip (SoC) or a large scale integration (LSI) circuit having a processing algorithm embedded therein, or may be implemented in a form of a field programmable gate array (FPGA).

In other words, the processor 30 may drive an execution program for rear-wheel steering control stored in the memory 20, and then receive a shift stage, a vehicle speed, and a front-wheel steering angle from the input module 10 to determine whether set conditions are satisfied.

For example, the processor 30 may determine whether the set conditions are satisfied, the set conditions including that the shift stage is reverse and the vehicle speed exceeds a first preset vehicle speed and is less than a second preset vehicle speed, and, when the set conditions are satisfied, may set the rear-wheel steering angle to a neutral state and drive the rear-wheel steering driving module 40, as illustrated in FIG. 2B.

In the case where the rear-wheel steering angle is steered in a counter-phase manner or an in-phase manner, the rear-wheel steering angle may be set to the neutral state to reduce yaw and roll, thereby improving stability and ride comfort, and also reducing instability during reverse driving, thereby reducing an accident rate.

As described above, when the rear-wheel steering angle is set to a counter phase and driven as illustrated in FIG. 2A, yaw and roll increase due to abrupt steering, thereby degrading steering performance and ride comfort; however, as illustrated in FIG. 2B, yaw and roll may be reduced by controlling the rear-wheel steering angle to the neutral state, thereby improving stability and ride comfort.

The processor 30 may drive the rear-wheel steering driving module 40 such that the rear-wheel steering angle satisfies a preset inclination, thereby preventing a sense of discomfort.

For example, the rear-wheel steering driving module 40 may be driven such that the rear-wheel steering angle varies at a rate of 4.5 degrees per second, thereby preventing abrupt variation and minimizing a sense of discomfort.

Even when the processor 30 sets the rear-wheel steering angle to a neutral state and then steers the rear-wheel steering angle in a counter-phase manner or an in-phase manner due to failure to satisfy set conditions, the rear-wheel steering driving module 40 is driven such that the rear-wheel steering angle is set to a preset inclination, thereby minimizing a sense of discomfort.

Furthermore, in the case where the vehicle speed is equal to or less than the first preset vehicle speed, the processor 30 may control the rear-wheel steering angle in the counter-phase state.

That is, because counter-phase control of the rear-wheel steering angle during reverse parking may increase parking efficiency, the processor 30 may release neutral control of the rear-wheel steering angle and perform the counter-phase control when the vehicle speed is equal to or less than the first preset vehicle speed corresponding to an extremely low speed.

In the case where the vehicle speed is equal to or higher than the second preset vehicle speed corresponding to a relatively high speed, the processor 30 may control the rear-wheel steering angle in the in-phase state.

As such, the processor 30, during reverse driving under set conditions, may perform neutral control of the rear-wheel steering angle within a preset vehicle speed range, and, at an extremely low speed for parking, may perform counter-phase control to reduce a turning radius, thereby improving steering efficiency.

On the other hand, during forward driving rather than reverse driving, when the vehicle speed is equal to or higher than a third preset vehicle speed corresponding to a high-speed driving condition, the processor 30 may control the rear-wheel steering angle in the in-phase state.

In the case where the vehicle speed is less than the third preset vehicle speed corresponding to low-speed driving, the processor 30 may control the rear-wheel steering angle in the counter-phase state.

As such, after setting the rear-wheel steering angle to an in-phase state or a counter-phase state, the processor 30 may calculate a target yaw rate using an inclination characteristic according to yaw acceleration based on a front-wheel steering angle, a yaw rate value, and a vehicle speed received from the input module 10, may calculate the rear-wheel steering angle such that the yaw rate value tracks the target yaw rate, and may drive the rear-wheel steering driving module 40.

As described above, in accordance with the rear-wheel steering control apparatus according to an embodiment of the present disclosure, when the rear wheels are steered relative to a front-wheel steering angle, neutral control is performed in a low-speed range during reverse driving and counter-phase control is performed during parking in an extremely low-speed range, thereby improving stability during reverse driving, and increasing steering efficiency by reducing a turning radius.

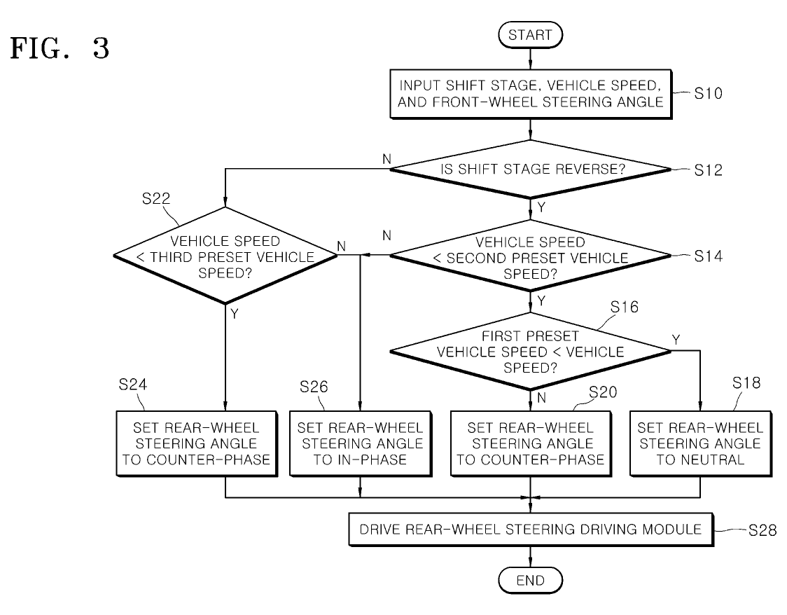

FIG. 3 is a flowchart illustrating a rear-wheel steering control method for a vehicle according to an embodiment of the present disclosure.

As illustrated in FIG. 3, in the rear-wheel steering control method according to an embodiment of the present disclosure, the processor 30 first executes an execution program stored in the memory 20 and then receives a shift stage, a vehicle speed, and a front-wheel steering angle from the input module 10 (S10).

After receiving the shift stage and the vehicle speed in step S10, the processor 30 determines whether the shift stage is reverse (S12).

In the present embodiment, in order to control a rear-wheel steering angle to a neutral state within a preset vehicle speed range during reverse driving and thereby resolve instability during reverse driving caused by abrupt steering, the processor 30 may first determine whether the shift stage is reverse.

In the case where it is determined in step S12 that the shift stage is reverse, the processor 30 determines whether the vehicle speed is less than the second preset vehicle speed (S14).

After determining in step S14 whether the vehicle speed is less than the second preset vehicle speed, when the vehicle speed is less than the second preset vehicle speed, the processor 30 determines whether the vehicle speed exceeds the first preset vehicle speed (S16).

That is, in the case where it is determined through steps S12, S14, and S16 that the vehicle state is a reverse driving state and the set conditions are satisfied in which the vehicle speed exceeds the first preset vehicle speed and is less than the second preset vehicle speed, the processor 30 sets the rear-wheel steering angle to a neutral state (S18).

Thereafter, the processor 30 may drive the rear-wheel steering driving module 40 to steer the rear wheels and align the rear wheels to a center position, thereby performing neutral control (S28).

Here, the processor 30 may drive the rear-wheel steering driving module 40 such that the rear-wheel steering angle satisfies a preset inclination, thereby preventing a sense of discomfort.

For example, the rear-wheel steering driving module 40 may be driven such that the rear-wheel steering angle varies at a rate of 4.5 degrees per second, thereby preventing abrupt variation and minimizing a sense of discomfort.

On the other hand, in the case where the vehicle speed is equal to or less than the first preset vehicle speed in step S16, the processor 30 sets the rear-wheel steering angle to a counter-phase state (S20).

That is, because counter-phase control of the rear-wheel steering angle during reverse parking may increase parking efficiency, the processor 30 may release the neutral control of the rear-wheel steering angle and perform the counter-phase control when the vehicle speed is equal to or less than the first preset vehicle speed corresponding to an extremely low speed.

On the other hand, in the case where the shift stage is reverse in step S14 and the vehicle speed exceeds the second preset vehicle speed, the processor 30 sets the rear-wheel steering angle to an in-phase state (S26).

Furthermore, when it is determined that the shift stage is not reverse but forward as a result of determining whether the shift stage is reverse in step S12, the processor 30 determines whether the vehicle speed is less than the third preset vehicle speed (S22).

In other words, during forward driving, when the vehicle speed is less than the third preset vehicle speed corresponding to low-speed driving, the processor 30 sets the rear-wheel steering angle to the counter-phase state and controls the rear-wheel steering angle accordingly (S24).

On the other hand, when the vehicle speed exceeds the third preset vehicle speed in step S22 during forward driving corresponding to high-speed driving, the processor 30 sets the rear-wheel steering angle to the in-phase state and controls the rear-wheel steering angle accordingly (S26).

After setting the rear-wheel steering angle to the in-phase state or the counter-phase state, the processor 30 calculates a target yaw rate using an inclination characteristic according to yaw acceleration based on a front-wheel steering angle, a yaw rate value, and a vehicle speed received from the input module 10, calculates the rear-wheel steering angle such that the yaw rate value tracks the target yaw rate, and drives the rear-wheel steering driving module 40 (S28).

As described above, according to the rear-wheel steering control method according to an embodiment of the present disclosure, when the rear wheels are steered relative to a front-wheel steering angle, neutral control is performed in a low-speed range during reverse driving and counter-phase control is performed during parking in an extremely low-speed range, thereby improving stability during reverse driving and increasing steering efficiency by reducing a turning radius.

The present disclosure has been described with reference to embodiments shown in the accompanying drawings, but these are merely illustrative, and those skilled in the art will recognize that various modifications and equivalent embodiments can be made therefrom.

Therefore, the true technical scope of the present disclosure should be defined by the following claims.

What is claimed is:

1. A rear-wheel steering control apparatus for a vehicle, comprising:
an input module configured to receive information about a state of the vehicle;
a rear-wheel steering driving module configured to steer rear wheels of the vehicle according to a rear-wheel steering angle; and
a processor operatively coupled to the input module and the rear-wheel steering driving module,
wherein the processor is configured to receive a shift stage, a vehicle speed, and a front-wheel steering angle from the input module, and, when a set condition is satisfied, set the rear-wheel steering angle to a neutral state and drive the rear-wheel steering driving module.

2. The rear-wheel steering control apparatus of claim 1, wherein the set condition includes a condition in which the shift stage is reverse and the vehicle speed exceeds a first preset vehicle speed and is less than a second preset vehicle speed.

3. The rear-wheel steering control apparatus of claim 2, wherein the processor is configured to control the rear-wheel steering angle in a counter-phase state when the vehicle speed is equal to or lower than the first preset vehicle speed.

4. The rear-wheel steering control apparatus of claim 2, wherein the processor is configured to control the rear-wheel steering angle in an in-phase state when the vehicle speed is equal to or higher than the second preset vehicle speed.

5. The rear-wheel steering control apparatus of claim 1, wherein the processor is configured to set the rear-wheel steering angle to the neutral state and drive the rear-wheel steering driving module such that the rear-wheel steering angle satisfies a preset inclination when the rear-wheel steering angle is released from the neutral state.

6. A rear-wheel steering control method for a vehicle, comprising:
receiving, by a processor, a shift stage, a vehicle speed, and a front-wheel steering angle from an input module;
determining, by the processor, whether the shift stage and the vehicle speed satisfy a set condition; and
when it is determined that the set condition is satisfied, setting, by the processor, a rear-wheel steering angle to a neutral state and driving a rear-wheel steering driving module.

7. The rear-wheel steering control method of claim 6, wherein the set condition includes a condition in which the shift stage is reverse and the vehicle speed exceeds a first preset vehicle speed and is less than a second preset vehicle speed.

8. The rear-wheel steering control method of claim 7, further comprising, when the vehicle speed is equal to or lower than the first preset vehicle speed,
controlling, by the processor, the rear-wheel steering angle in a counter-phase state.

9. The rear-wheel steering control method of claim 7, further comprising, when the vehicle speed is equal to or higher than the second preset vehicle speed,
controlling, by the processor, the rear-wheel steering angle in an in-phase state.

10. The rear-wheel steering control method of claim 6, wherein the driving of the rear-wheel steering driving module comprises
setting, by the processor, the rear-wheel steering angle to the neutral state and driving the rear-wheel steering driving module such that the rear-wheel steering angle satisfies a preset inclination when the rear-wheel steering angle is released from the neutral state.
